(19) United States
(12) Patent Application Publication
(10) Pub. No.: US 2010/0089894 A1
(43) Pub. Date: Apr. 15, 2010

(54) Heating Apparatus

(76) Inventor: Simon Nicholas Richmond, Princeton, NJ (US)

Correspondence Address: LAW OFFICES OF DONALD COX, P.O. BOX 505, PRINCETON, NJ, 08542-0505, US

(21) Appl. No.: 12/579,389

(22) Filed: Oct. 14, 2009

Related U.S. Application Data
(60) Provisional application No. 61/195,969, filed on Oct. 14, 2008.

(51) Int. Cl. B60L 1/02; H05B 1/00

(52) U.S. Cl. 219/202; 219/217

(57) ABSTRACT

The present invention is embodied in a heating apparatus having a removable vehicle seat cover having a back portion and a seat portion with at least one electrical heating element affixed to the removable vehicle seat cover. A power cord is included having a vehicle coupler releasably connectable to a vehicle power supply and at least one controller connector for releasable electrical connection to the at least one electrical heating element. A bilaterally accessible power coupler is located along at least one side of the removable vehicle seat cover and is connected in circuit with the at least one heating element. The bilaterally accessible power coupler and the at least one controller connector are formed complementary to create an electrical connection; and, when the removable vehicle seat cover is installed over a vehicle seat, the bilaterally accessible power coupler is located outside regions of the removable vehicle seat cover typically in contact with a torso and legs of an individual seated in the vehicle seat.

### CROSS REFERENCE TO RELATED APPLICATION(S)

This application claims the benefit of U.S. Provisional Application Ser. No. 61/195,969, filed on Oct. 14, 2008; the contents of which are all hereby incorporated by reference.

### BACKGROUND OF THE INVENTION

1. Field of the Invention

The present invention relates to a portable heating apparatus and, more particularly, to a heating apparatus for a removable vehicle seat cover of a vehicle.

2. Description of the Related Art

With the advent of after market heating devices for vehicle seats, such devices tend to have a power cable exiting the seat heater at a single front region of the car seat or at a single side of the car seat. Normally, this power cable needs to be connected to a lighter or power socket located relatively centrally on a front console so it is accessible from either driver or passenger sides. However, guiding the power cable to the power socket when such cable exits at the front of the car seat has the problem of a risk of entanglement with the legs of a driver of the vehicle using the seat heater and thus potentially interfering with the driver's ability to appropriately use the brake pedal, accelerator pedal or clutch pedal and thus creating a potentially dangerous driving hazard or causing the driver to trip on the power cable upon exiting the vehicle and thus having a potentially dangerous fall.

One such solution has been to place the power socket on a seat cover. Such a configuration means that due to the generally centrally located power socket in a vehicle that the exit location of the power cable from the car seat can be either the left side of the right side of the car seat for specific left side car seat and right side car seat versions. However, such an arrangement with the car seat heating devices have a single connection point on either a right or left side corresponding to either a driver or passenger seat in a vehicle. These specific locations are to avoid the risk of tangling the heated seat cover power cable with the legs of the driver and thus restricting use of the floor pedals by the driver thus creating a potentially dangerous driving hazard. Accordingly, as a retailer cannot know in advance whether a user prefers to use such a device for a driver or passenger seat they would need to offer both a Left side connector model and a right side connector model.

This would thus necessitate the retailer stocking 2 models of each heated seat cover, a “driver-side model” and a passenger-side model”. This raises their inventory holding levels which is undesirable. A further problem arises with international retailers. As some vehicles have the driver side on the right side as in Hong Kong and some vehicles have the driver side on the left side as in China, right across the drivable border from Hong Kong, it becomes difficult for a retailer to offer individual models as a “driver-side model” and a “passenger side-model” in this region as there is confusion between the models.

A further problem exists with 2^{nd} row passenger seats. Previously, second row passenger seats were bench style. Recently, freestanding bucket style 2^{nd} row seats are now commonly found on some newer minivans and some Sport Utility Vehicles. These seats are found both on the passenger side and driver side so marketing 2 models as a “driver-side model” and a passenger-side model” would result in consumer confusion for use with such second row seats.

To avoid the abovementioned confusion and because most retailers generally prefer to carry fewer models of a similar item in their stores to better manage inventory levels, some retailers would have preferred to carry only one model. Accordingly, both the left side model and the right side model are bundled as a pair with a common electrical controller unit.

However, this approach is problematic for the merchandising approaches of some retailers who are unwilling to offer this bundled left and right seat option due to the significantly higher consumer retail cost involved than selling a single seat cover. These retailers simply choose not to offer any of the products.

The present invention overcomes the difficulty of needing to offer either a bundled set of 2 seat covers or a specific “driver side” or passenger side” model because the present invention involves making a new model that can be used on either driver or passenger side. The present invention overcomes the need to stock two models by retailer. The present invention opens up interest from retailers just wishing to stock a single seat cover model. The present invention overcomes the abovementioned confusion with 2^{nd} row seat options.

Therefore, it can be appreciated that there exists a need for a new and improved heated car seat cover which can be detachably fitted to a vehicle seat. In this regard, the present invention substantially fulfils this need.

### BRIEF SUMMARY OF THE INVENTION

The present invention is embodied in a heating apparatus having a removable vehicle seat cover having a back portion and a seat portion with at least one electrical heating element affixed to the removable vehicle seat cover. A power cord is included having a vehicle coupler releasably connectable to a vehicle power supply and at least one controller connector for releasable electrical connection to the at least one electrical heating element. A bilaterally accessible power coupler is located along at least one side of the removable vehicle seat cover and is connected in circuit with the at least one heating element. The bilaterally accessible power coupler and the at least one controller connector are formed complementary to create an electrical connection; and, when the removable vehicle seat cover is installed over a vehicle seat, the bilaterally accessible power coupler is located outside regions of the removable vehicle seat cover typically in contact with a torso and legs of an individual seated in the vehicle seat.

The power cord includes a control switch assembly for varying the power to the at least one flexible electrical heating element from the vehicle power supply.

The control switch assembly is operative in one embodiment to change the amount heat delivered through the vehicle seat cover.

The control switch assembly is operative in an alternate embodiment to change the location of the heat delivered through the vehicle seat cover from the seat portion to the seat and back portion.

The bilaterally accessible power coupler in one embodiment includes two bilaterally positioned couplers connected in parallel to the at least one heating element layer and use of only one of the bilaterally positioned couplers with the at least one controller connector is required to power the at least one heating element.

In an alternate embodiment, the bilaterally accessible power coupler includes a releasably mounted coupler connected in circuit with the at least one heating element layer by an electrical cord that permits positioning and releasable mounting of the releasably mounted coupler on either side of the removable vehicle seat cover.

In an alternate embodiment, a heating apparatus includes a removable vehicle seat cover having a back portion and a seat portion with at least one electrical heating element affixed to the removable vehicle seat cover. A power cord has a vehicle coupler releasably connectable to a vehicle power supply and at least one controller connector for releasable electrical connection to the at least one electrical heating element. Two bilaterally positioned couplers are connected in parallel to the at least one heating element layer wherein the bilaterally positioned couplers and the at least one controller connector are formed complementary to create an electrical connection such that use of only one of the bilaterally positioned couplers with the at least one controller connector is required to power the at least one heating element.

These and other features, objects and advantages of the present invention will be evident from and will be more fully understood by reference to the following drawings and detailed description of the invention.

### BRIEF DESCRIPTION OF THE DRAWINGS

FIG. 1 is a diagrammatic front view of the heating apparatus in accordance with the preferred embodiment of the present invention.

FIG. 2 is a diagrammatic perspective view of the heating apparatus as shown in FIG. 1, partially fitted to a conventional seat of a vehicle.

FIG. 3 is a diagrammatic first side perspective view of the heating apparatus as shown in FIG. 1, fitted to the conventional seat of a vehicle of FIG. 2.

FIG. 4 is a diagrammatic second side perspective view of the heating apparatus as shown in FIG. 1, fitted to the conventional seat of a vehicle of FIG. 2.

FIG. 5 is a diagrammatic perspective view of a power and control cable assembly of the heating apparatus as shown in FIG. 1.

FIG. 6 is a diagrammatic perspective view of a first conducting coupler of the heating apparatus as shown in FIG. 1.

FIG. 7 is a diagrammatic perspective view of a second conducting coupler of the heating apparatus as shown in FIG. 1.

FIG. 8A is a diagrammatic view of the heating apparatus as shown in FIG. 1, installed in a conventional seat of a vehicle.

FIG. 8B is a diagrammatic view of the heating apparatus as shown in FIG. 1, installed in two conventional front seats of a vehicle.

FIG. 9 is a schematic view of a heating circuit of the heating apparatus as shown in FIG. 1.

FIG. 10 is a schematic view of an alternate heating circuit embodiment of the heating apparatus as shown in FIG. 1.

FIG. 11 is a diagrammatic view of a prior art heating apparatus, installed in two conventional front seats of a vehicle.

FIG. 12 is a diagrammatic view of the heating apparatus as shown in FIG. 1, installed in two conventional front seats of a vehicle.

FIG. 13 is a schematic view of a heating circuit of the heating apparatus as shown in FIG. 1.

FIG. 14 is a schematic view of an alternate heating circuit embodiment of the heating apparatus as shown in FIG. 1.

FIG. 15 is a diagrammatic view of a prior art heating apparatus, installed in two conventional front seats of a vehicle.

### DETAILED DESCRIPTION OF THE INVENTION

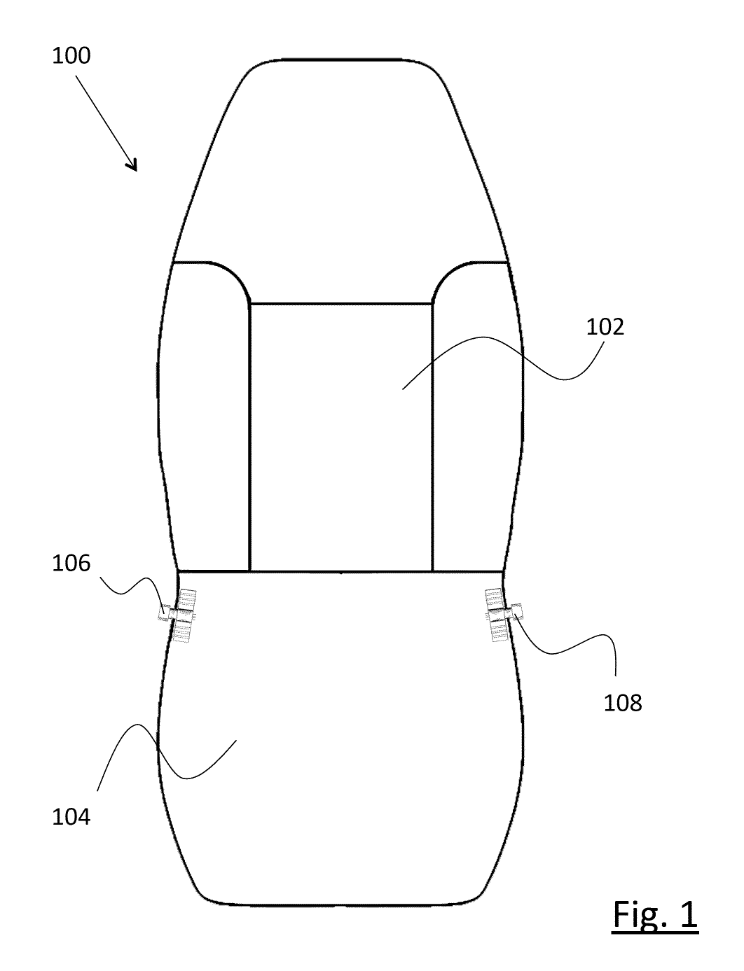

With reference to the drawings for purposes of illustration, FIG. 1 shows a heated car seat cover assembly having a removable vehicle seat cover portion 100 that comprises a back portion 100 and a seat portion 104. Advantageously, affixed to the main removable vehicle seat cover portion 100 adjacent to the intersection of the back portion 100 and the seat portion 104 is a bilaterally accessible power coupler located along at least one side of the heated car seat cover assembly which in the presently preferred embodiment is in the form of two bilaterally positioned connectors each along the sides of the assembly identified as a first left side connector 108 and a second right side connector 106. The term “bilaterally accessible power coupler” should not be limited to this preferred embodiment, but is intended to include connectors positioned on both sides of the assembly or a single connector (not shown) separated assembly by a cable that is releasably mounted on the assembly and moveable between either side of the assembly for bilateral access.

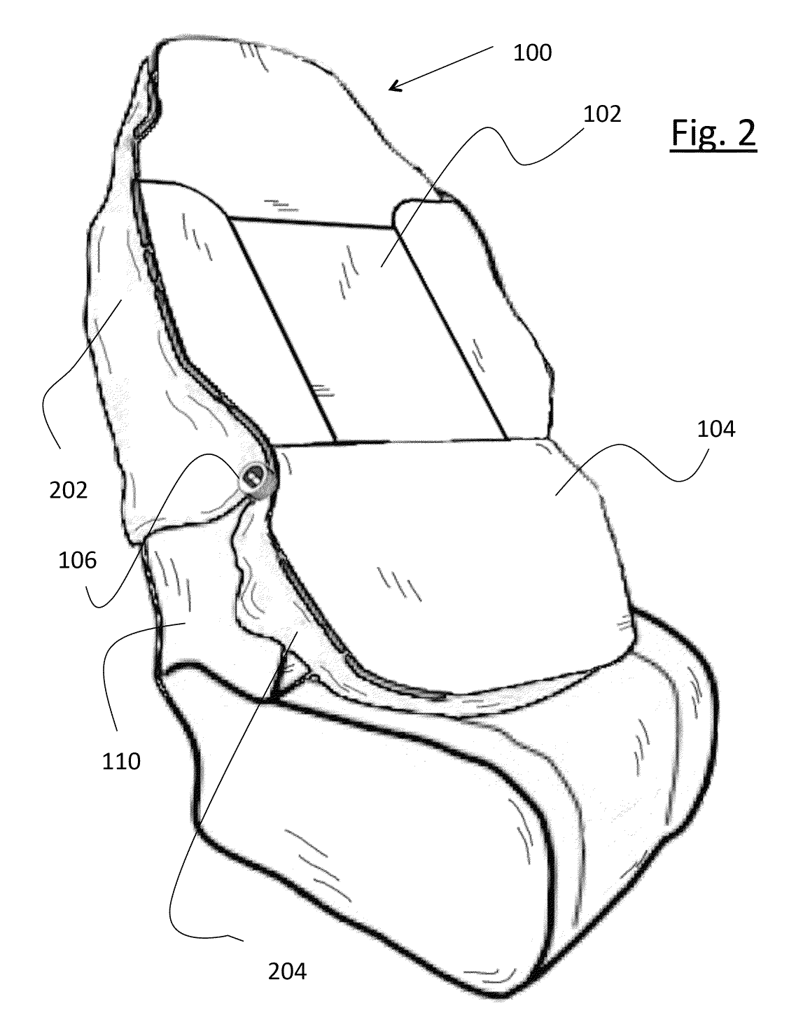

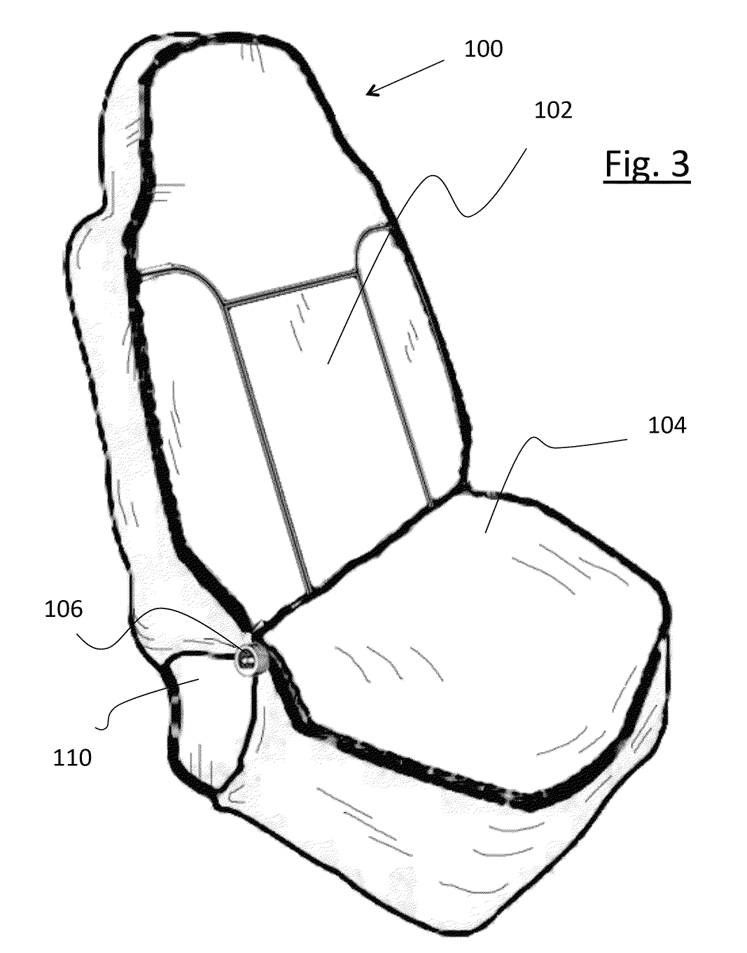

As shown in FIGS. 2 and 3, the removable vehicle seat cover portion 100 is slid over a vehicle seat so that the second right side connector 106 is positioned at the side of the seat preferably near the right side intersection of the back and seat portion of the car seat 110.

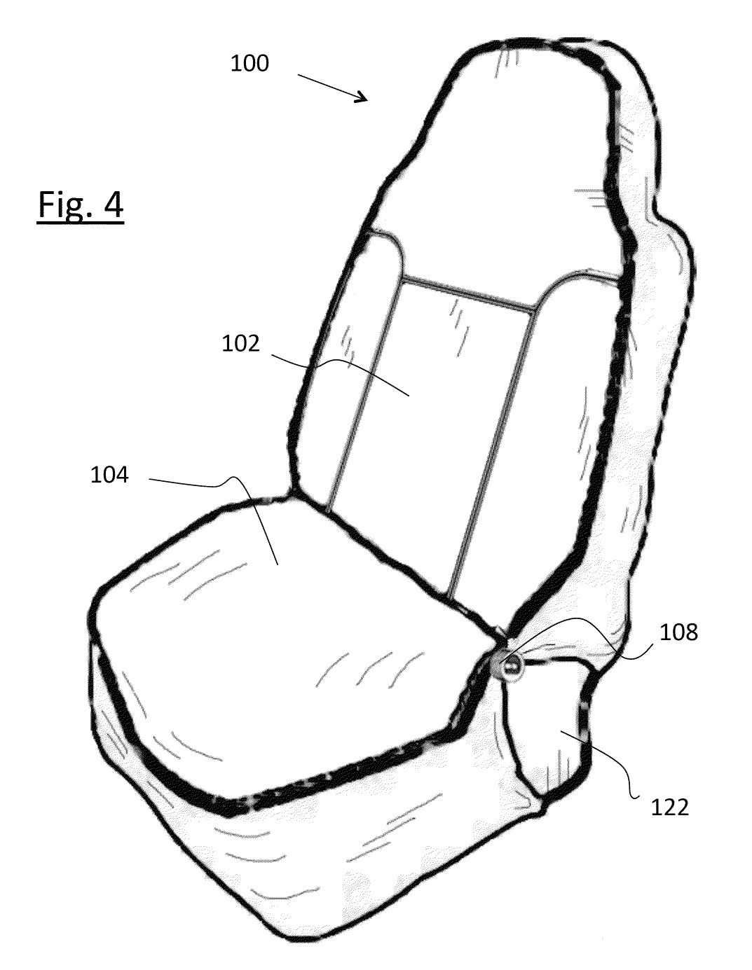

FIG. 4 shows the same seat 100 from a different perspective now showing the first left side connector 108 adjacent to the left side intersection of the back and seat portion of the car seat 122.

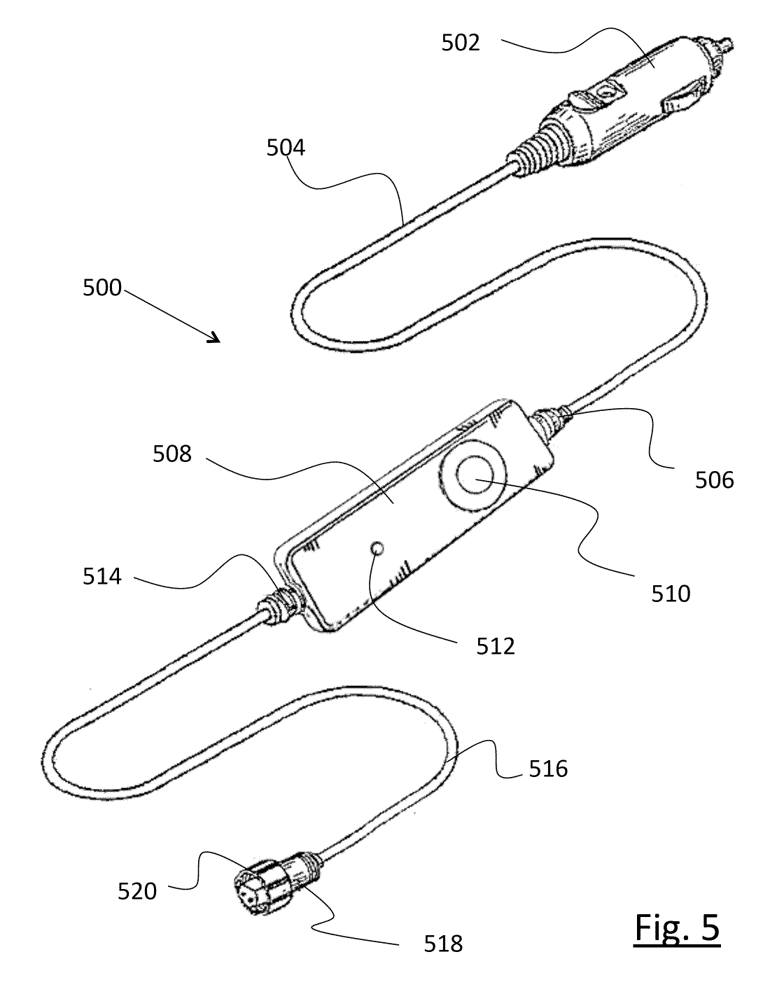

FIG. 5. shows the power supply and control assembly having a standard detachable plug 502 that connects to a vehicles cigarette lighter or power socket. The detachable plug 502 connected to a controller module 508 via a power supply cable 504 which supplies power from the vehicle's battery to the controller module. The controller module has a user input device 510 such a push switch, pressure switch, inductive switch, slide switch or any other suitable user-controllable interface device including a wireless receiver (not shown). At least one indicator 512 is also located on a visible surface of the controller module 508 to indicate the user to the presence of power and/or level of heat. Preferably this indicator 512 is a tri-color indicator showing the colors red, green and orange at different user-selected power levels for different heating comfort levels.

The user input device 510 is preferably a push switch which provides an audible and tactile feedback to the user that the input device 510 has been activated so the user does not need to visually refer to the indicator 512 while driving the vehicle in motion which makes for safer use. The controller module 508 is electrically connected to a controller connector 518 via a controller cable 516. A controller cable strain relief 514 is provided between the controller cable 526 and the controller module 508 at the intersection of the controller cable 516 and the controller module 508. A power supply strain relief 506 is provided between the power supply cable 504 and the controller module 508 at the intersection of the power supply cable 504 and the controller module 508. The distance between the controller connector 518 and the detachable plug 502 when the power supply cable 504 and controller cable 516 are fully extended is of appropriate length to reach from the intersection of the back and seat portion of the car seat 110 and 118 to the vehicle's centrally located power socket. Preferably the controller connector 518 has a securing ring 520 to prevent unintentional detachment of the securing ring from the seat cover 100 when in use.

In the preferred embodiment, when the power is provided to the controller module 508 via the standard detachable plug 502 and the controller user-operable button 510 is depressed once, the controller indicator light 512 illuminates and displays a red color. Internally, a circuit within the controller module 508 allows a maximum predetermined current to pass through the controller module 508 and out through the controller connector 518 to the heating elements within the car seat cover 100. This is termed the “HIGH” level of heat setting. When the controller user-operable button 510 is depressed a second time, the controller indicator light 512 illuminates and displays an orange color. Internally, the circuit pulses in a timed manner, the current passing out through the controller module 508 and out through the controller connector 518 to the heating elements. This is termed the “MEDIUM” level of heat setting. When the controller user-operable button 510 is depressed a third time, the controller indicator light 512 illuminates and displays a green color. Internally, the circuit within the controller module 508 circuit pulses in a timed manner with a wider pulsing “off” time, the current passing out through the controller 508 and out through the controller connector 518 to the heating elements. This is termed the “LOW” level of heat setting. When the controller user-operable button 510 is depressed a fourth time, the controller indicator light 512 ceases to illuminates. Internally, the circuit within the controller module 508 cuts the current flowing to the heating elements. This is termed the “OFF” setting. The control cycle may be repeated by continued depressing of the controller user-operable button 510.

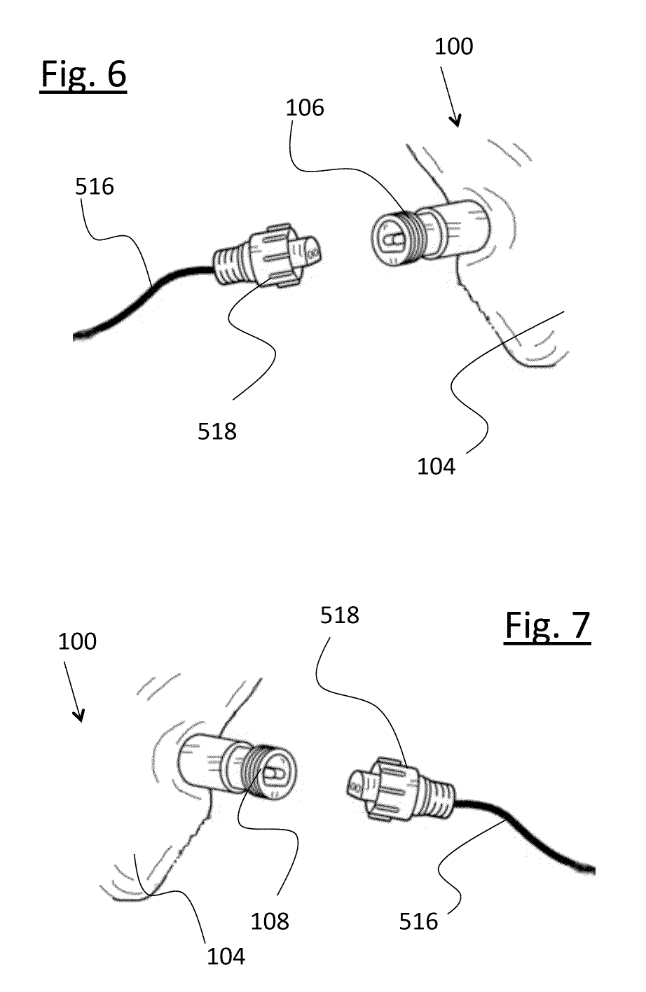

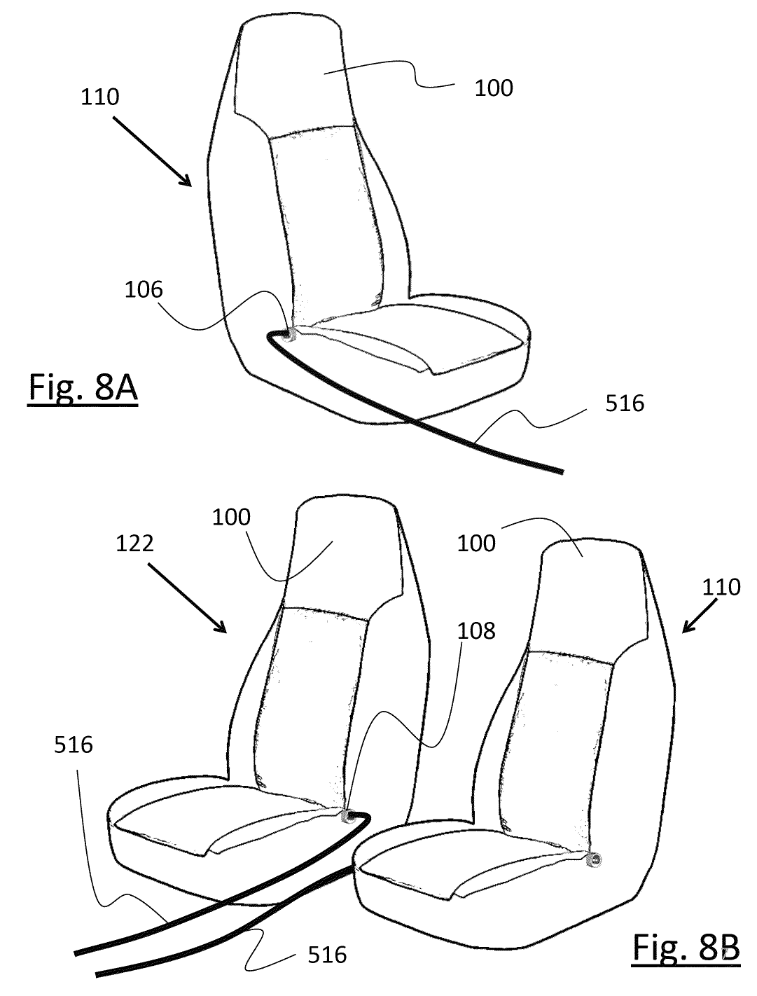

FIG. 6 shows a closer view of a part of the removable vehicle seat cover portion 100 shown in FIGS. 2 and 3 with the second right side connector 106 positioned at the side of the seat near the right side intersection of the back and seat portion 104. The controller connector 518 detachably connects with the second right side connector 106 to provide power from the vehicle's battery to the heated seat cover via the controller cable 516. Also shown with the whole car seat cover 100 in FIG. 8A, in this configuration the controller cable 516 departs from the second right side connector 106 on the right side of the seat so would be suitable for use with a driver-side seat 110 in a USA configured vehicle as this right side location is proximate to the central socket location of the vehicle's power. As used throughout the specification the term “USA configured vehicle” refers vehicles generally used in countries where drivers adhere to the right-side of the road when encountering on-coming traffic and the steering column is generally positioned for use on the left side of the vehicle and is not intended to be limiting to this invention, but to provide an understanding of the orientation of the driver's or passenger's seat within the vehicle. It will be understood by those skilled in the art that such orientations are reversed in countries drives adhere to the left-side of the road when encountering on-coming traffic.

Alternatively, as shown in FIG. 7, which shows closer view of a part of the removable vehicle seat cover portion 100 shown in FIG. 4 with the first left side connector 108 positioned at the side of the seat near the left side intersection of the back and seat portion 122. The controller connector 518 detachably connects with the first left side connector 108 to provide power from the vehicle's battery to the heated seat cover via the controller cable 516. Also shown with the whole car seat cover 100 in FIG. 8B, in this configuration the controller cable 516 departs from the second right side connector 108 on the right side of the seat so would be suitable for use with a passenger-side seat 122 in a USA configured vehicle as this right side location is proximate to the central socket location of the vehicle's power. Alternatively, two or more such seat covers 100 may be configured in a vehicle as shown in FIG. 8B such that the controller cable 516 can be safely aligned along a central region towards the power socket. It will be appreciated by those skilled in the art of human factors engineering that this configuration provides the most elegant and discrete alignment of the power cables relative to a central power source while avoiding the area generally used by occupants of the vehicle.

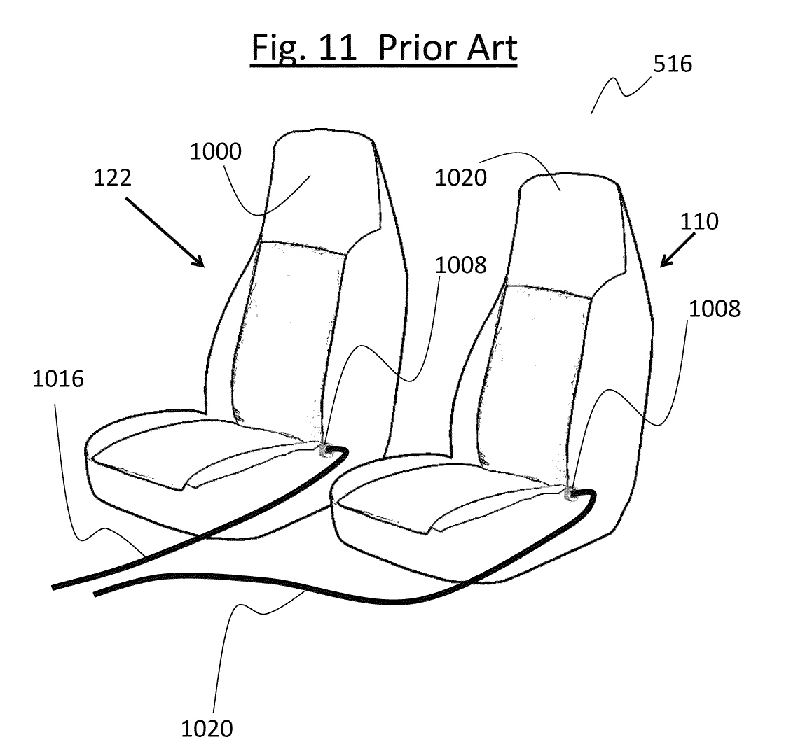

As shown in FIG. 11, under a prior art single left side connector 1008 used in conventional car seat covers, the car seat cover 1000 when installed on a USA passenger side vehicle seat 122 would have a safe cable routing path for the connector cable 1016 but when installed on a USA driver side seat 110 the car seat cover 1020 would have a potentially dangerous routing path 1020 past the legs of the driver.

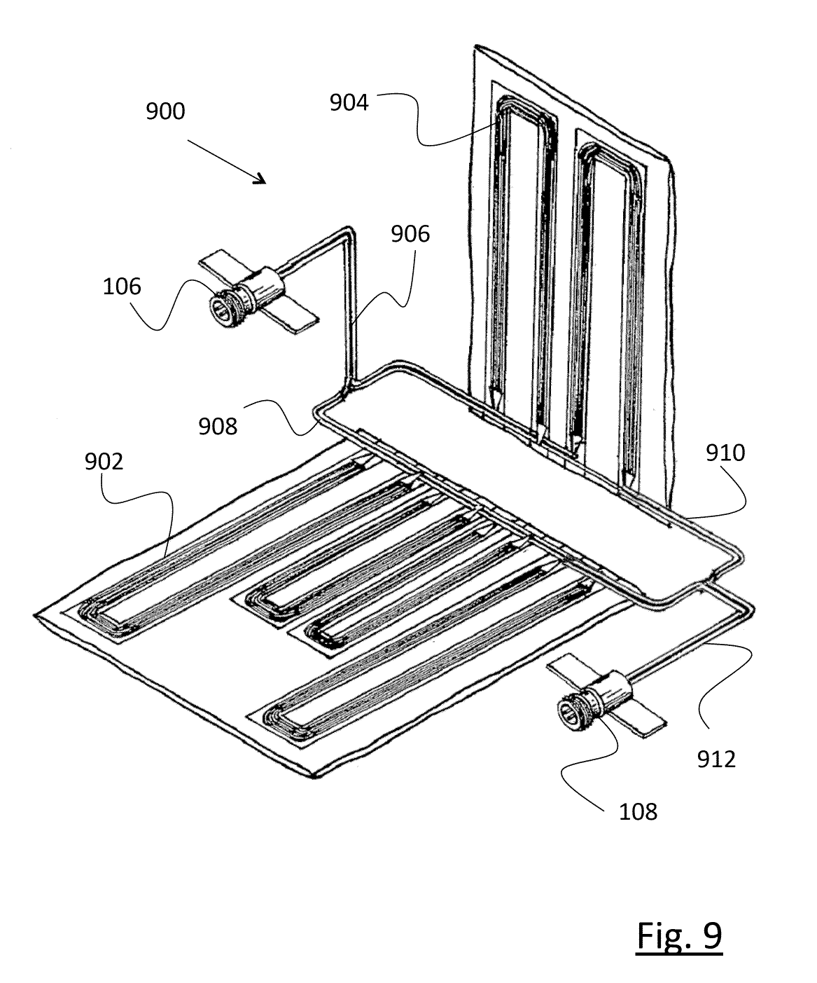

As shown in FIG. 9, a flexible heating assembly 100 includes a heating circuit 900 having a back heating region 904 and a seat heating region 902. Power is provided to back heating region 904 and the seat heating region 902 via conductive elements 910 and 908 from either the first left side connector 108 via conductive elements 912 or in parallel from the second right side connector 106 via conductive elements 906. In one embodiment there is no back heating region 904 only a seat heating region 902. Preferably heating elements 904 and 902 are made from bundles of carbon fiber but any suitable heating element would suffice. Notably, the heating elements 902 and 904 are formed from a series of loops of heating elements which permits the power leads 908 and 910 to be centrally located at the junction of the seat and back regions between the connectors 106 and 108. It will be appreciated that a thermostat (not shown) may be included in the circuit to create an open circuit and disconnect power when the temperature of the seat reaches a predetermined threshold. Furthermore, the separate pathways for supplying power can be connected in parallel at the connector or they can be configured to receive separate power loads from the control assembly to there by permit selective zone heating of the seat and/or back portions.

As shown in FIG. 11, a flexible heating assembly 100 includes an alternate heating circuit 950 having a back heating region 954 and a seat heating region 952. Power is provided to back heating region 954 and the seat heating region 952 via conductive elements 960 and 958 from either the first left side connector 968 via conductive elements 962 or in parallel from the second right side connector 966 via conductive elements 956. In one embodiment there is no back heating region 954 only a seat heating region 952. Preferably heating elements 954 and 952 are made from bundles of carbon fiber but any suitable heating element would suffice. Notably, the heating elements 952 and 954 are formed from a series of parallel lines of heating elements which permits greater redundancy should any individual heating element fail and become an open circuit. It will be appreciated that at least one thermostat 964 may be included in the circuit to create an open circuit and disconnect power when the temperature of the heating assembly reaches a predetermined threshold. Furthermore, the separate pathways for supplying power can be connected in parallel at the connector. Alternatively, when a third lead (shown by dotted line 970) is used to receive a separate power load from the control assembly an open circuit such as at location 972 to permit selective heating of the seat and/or back regions to thereby permit selective zone heating of the seat and/or back portions.

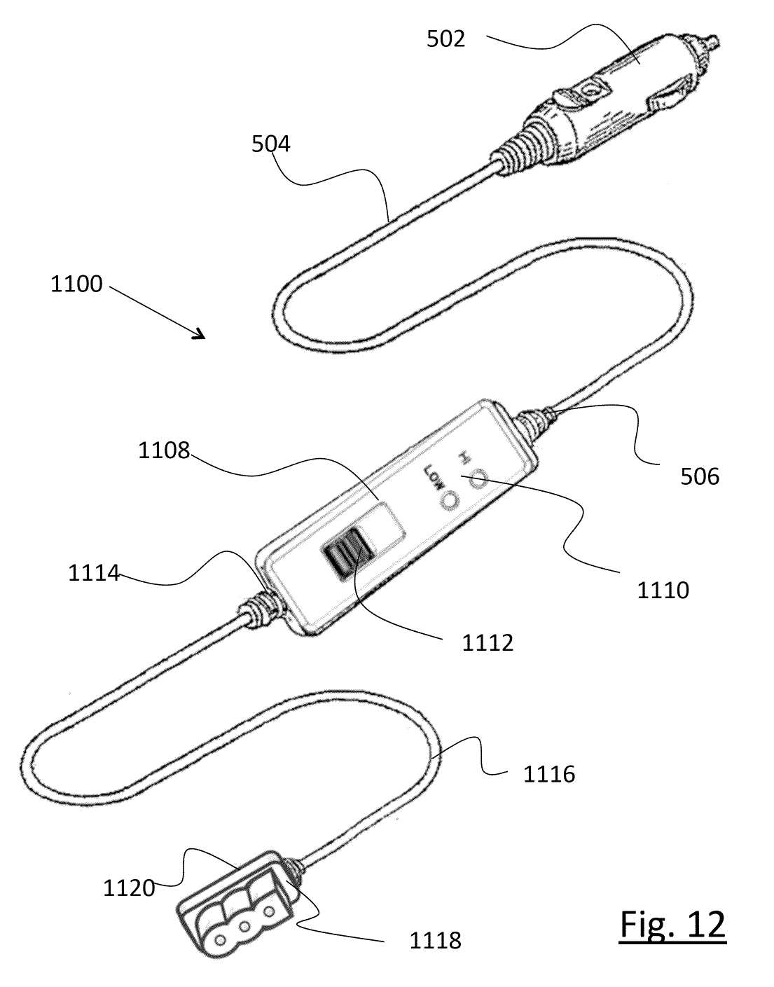

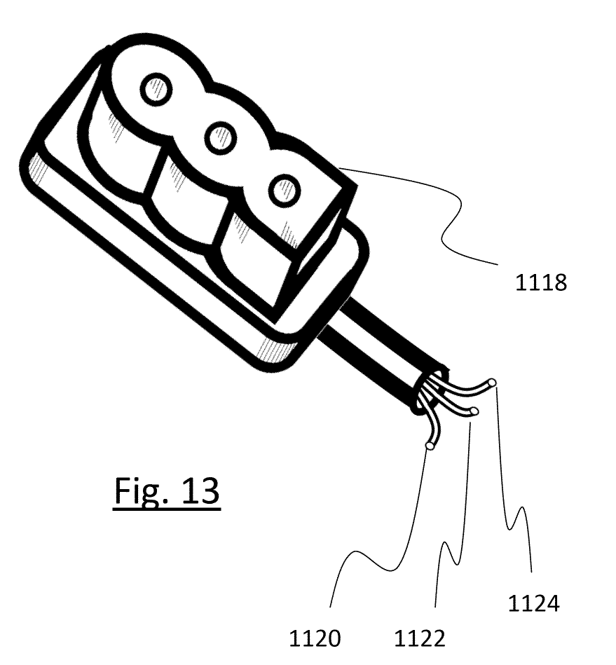

With reference to FIGS. 12-15, an alternatively preferred embodiment of a power supply and control assembly 1100 for supplying varying loads to the seat assembly has a standard detachable plug 502 that connects to a vehicles cigarette lighter or power socket. The detachable plug 502 connected to a controller module 1108 via a power supply cable 504 that supplies power from the vehicle's battery to the controller module. The controller module has a user input device 1112 such as a three-position slide switch. Other suitable switches may include a pressure switch, inductive switch, push switch or any other suitable user-controllable interface device including a wireless receiver (not shown). At least one indicator 1110, represented as two indicators for High and Low setting in this embodiment, is also located on a visible surface of the controller module 1108 to indicate the user to the presence of power and/or level of heat. Preferably this two lamp indicator 1110 is a single color indicator showing either a lamp lit near the “high” or “low” indicator to correspond to the position of the slide switch at different user-selected power levels for different heating comfort levels. The absence of any lamp lit would signify that the power is “off”.

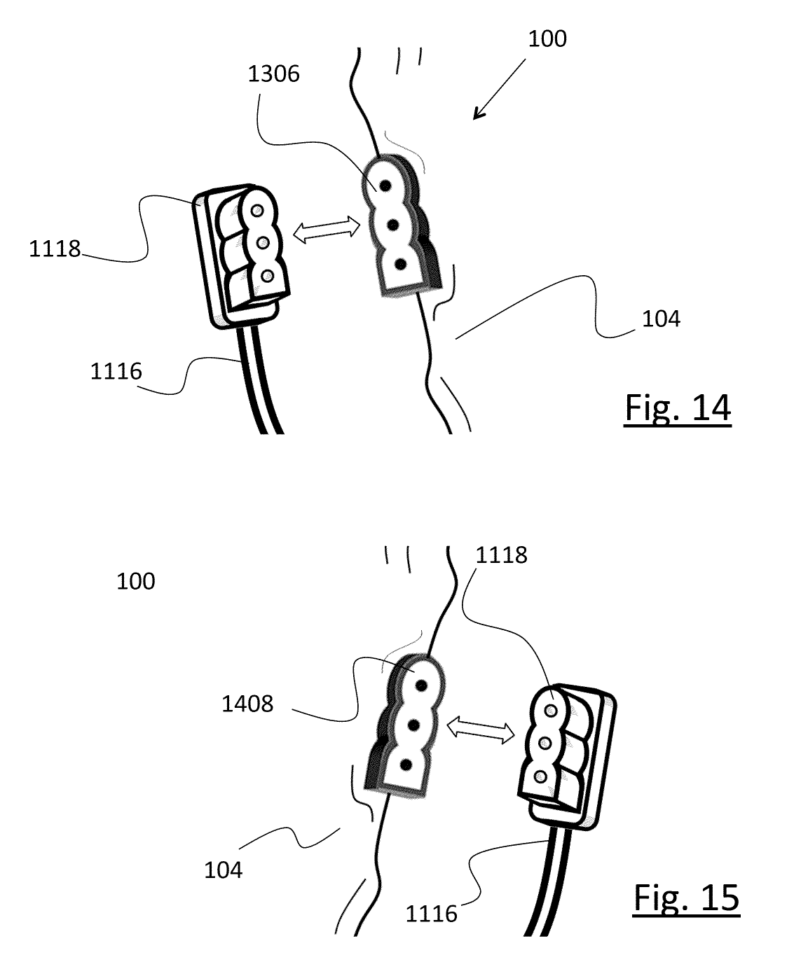

The user input device 1112 is preferably a three position slide switch which may provide an audible and/or tactile feedback to the user that the input device 1112 has been activated so the user does not need to visually refer to the indicator 1110 while driving the vehicle in motion which makes for safer use. The controller module 1108 is electrically connected to a controller connector 1118 via a controller cable 1116. The three positions of the switch cooperates with three electrical leads in the controller connector, namely a negative lead 1120 that connects to the vehicles negative terminal or ground and two positive leads 1122 and 1124 that permit heating of different heating element circuits in the cover assembly. A controller cable strain relief 1114 is provided between the controller cable 1116 and the controller module 1108 at the intersection of the controller cable 1116 and the controller module 1108. A power supply strain relief 506 is provided between the power supply cable 504 and the controller module 1108 at the intersection of the power supply cable 504 and the controller module 1108. The distance between the controller connector 1118 and the detachable plug 502 when the power supply cable 504 and controller cable 1116 are fully extended is of appropriate length to reach from the intersection of the back and seat portion of the car seat 110 and 118 to the vehicle's centrally located power socket. Preferably the controller connector 1118 has a securing feature 1120 to prevent unintentional detachment of the securing ring from the seat cover 100 when in use. In the present embodiment, the securing feature is in the form of complimentary rubber walls that form a snug, pressure fit engagement between the plug 1118 and socket 1408 (FIG. 15) or 1306 (FIG. 14). Other suitable securing features may include a securing ring, a securing latch or a securing screw, similar to screw engagements now common of battery covers.

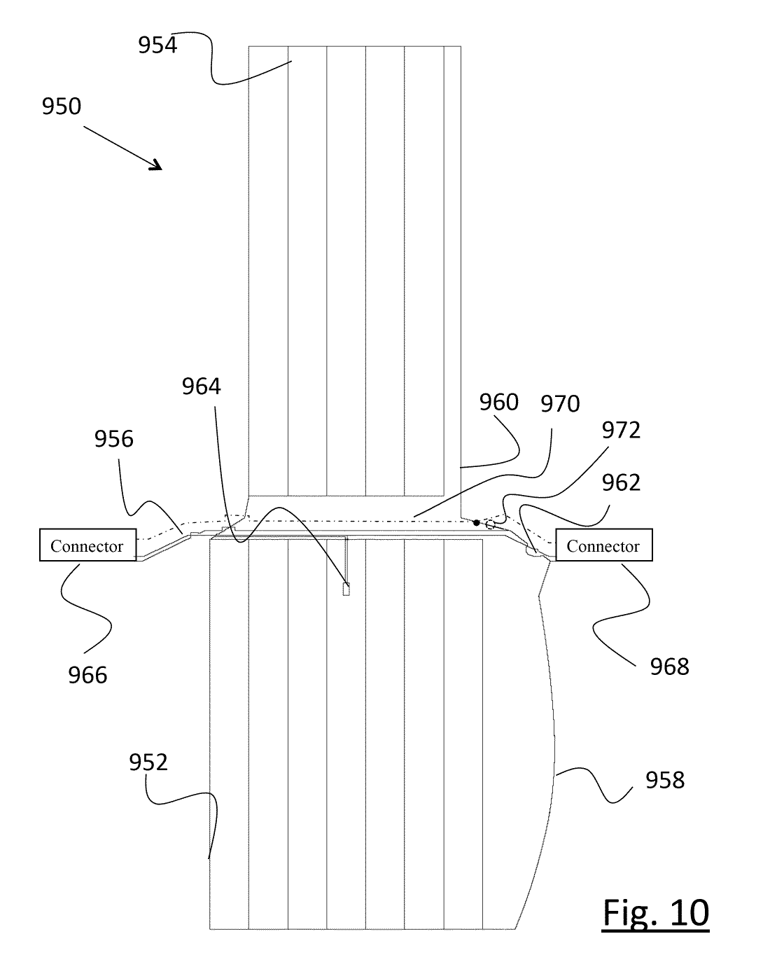

With continued reference to FIGS. 12-15, when the power is provided to the controller module 1108 via the standard detachable plug 502 and the controller user-operable switch 1112 is slid from an “off” position to a first “on” position, the controller indicator light 1110 illuminates and displays a light near the “low” setting. Internally, a circuit within the controller module 1108 allows current to pass through the controller module 1108 and out through a first lead in connector to some of the heating elements within the car seat cover 100. This is termed the “LOW” level of heat setting. When the controller user-operable switch 1112 is slid to a second “on” position, the controller indicator light 1110 illuminates and displays a light near the “high” setting. Internally, the circuit within the controller module 1108 allows current to pass through the controller module 1108 and out through the first lead in connector and out through a second lead in the connector to all of the heating elements within the car seat cover 100. This is termed the “HIGH” level of heat setting. It will be appreciated by those skilled in the art that the difference between the “low” and “high” setting can configured differently in the cover assembly such that a configuration as in FIG. 10 would allow for the “LOW” setting to heat either the back region or the seat region. While in another embodiment the heating elements for each lead may be organized in overlapping arrangements such that powering both leads provides a greater density of heating elements across an area for a “high” and “low” heating temperature effect.

Although the invention has been described in language specific to structural features and/or methodological acts, it is to be understood that the invention defined herein is not necessarily limited to the specific features or acts described. Rather, the specific features and acts are disclosed as exemplary forms of implementing the claimed invention.

What is claimed is:

1. A heating apparatus comprising:
a removable vehicle seat cover having a back portion and a seat portion;
at least one electrical heating element affixed to said removable vehicle seat cover;
a power cord having a vehicle coupler releasably connectable to a vehicle power supply and at least one controller connector for releasable electrical connection to said at least one electrical heating element;
a bilaterally accessible power coupler located along at least one side of said removable vehicle seat cover and connected in circuit with said at least one heating element;
wherein said bilaterally accessible power coupler and said at least one controller connector are formed complementary to create an electrical connection; and
wherein, when said removable vehicle seat cover is installed over a vehicle seat, said bilaterally accessible power coupler is located outside regions of said removable vehicle seat cover typically in contact with a torso and legs of an individual seated in said vehicle seat.

2. The heating apparatus of claim 1 wherein said power cord includes a control switch assembly for varying the power to said at least one flexible electrical heating element from said vehicle power supply.

3. The heating apparatus of claim 1 wherein said bilaterally accessible power coupler includes two bilaterally positioned couplers connected in parallel to said at least one heating element layer and use of only one of said bilaterally positioned couplers with said at least one controller connector is required to power said at least one heating element.

4. The heating apparatus of claim 1 wherein said bilaterally accessible power coupler includes a releasably mounted coupler connected in circuit with said at least one heating element layer by an electrical cord to permit positioning and releasable mounting of said releasably mounted coupler on either side of said removable vehicle seat cover.

5. The heating apparatus of claim 1 wherein said complementary formation of said bilaterally accessible power coupler and said at least one heating element layer coupler includes a complementary male plug and a complementary female socket.

6. The heating apparatus of claim 5 wherein said bilaterally accessible power coupler is said female socket and said at least one heating element layer coupler is male plug.

7. The heating apparatus of claim 1 wherein said complementary formation of said bilaterally accessible power coupler and said at least one heating element layer coupler includes shapes for each that are identifiable and capable of alignment by touch by an individual with limited or no actual line of sight with a location where said bilaterally accessible power coupler and said at least one heating element layer coupler are to be connected.

8. The heating apparatus of claim 7 wherein said complementary shapes are generally curved with one surface being generally planar.

9. The heating apparatus of claim 6 wherein said complementary formation of said bilaterally accessible power coupler and said at least one heating element layer coupler includes shapes for each that are identifiable and capable of alignment by touch by an individual with limited or no actual line of sight with a location where said bilaterally accessible power coupler and said at least one heating element layer coupler are to be connected.

10. The heating apparatus of claim 9 wherein said complementary shapes are generally curved with one surface being generally planar.

11. The heating apparatus of claim 1 wherein said power cord includes one controller connector.

12. The heating apparatus of claim 2 wherein said at least one heating element includes two heating elements and said control switch assembly selectively varies power to one or two of said heating element.

13. The heating apparatus of claim 12 wherein said two heating elements are positioned in spaced apart relation to each other.

14. The heating apparatus of claim 12 wherein said two heating elements are positioned in overlapping relation to each other.

15. The heating apparatus of claim 12 wherein said two heating elements are positioned such that a first heating element is in a seat region and a second heating element is in a back region of said removable vehicle seat cover.

16. A heating apparatus comprising:
a removable vehicle seat cover having a back portion and a seat portion;
at least one electrical heating element affixed to said removable vehicle seat cover;
a power cord having a vehicle coupler releasably connectable to a vehicle power supply and at least one controller connector for releasable electrical connection to said at least one electrical heating element;
two bilaterally positioned couplers connected in parallel to said at least one heating element layer;
wherein said bilaterally positioned couplers and said at least one controller connector are formed complementary to create an electrical connection such that use of only one of said bilaterally positioned couplers with said at least one controller connector is required to power said at least one heating element.

17. The heating apparatus of claim 16 wherein said at least one heating element includes two heating elements wherein at least one of said heating elements is capable of being powered independently.

18. The heating apparatus of claim 16 wherein said at least one controller connector and said two bilaterally positioned connectors include at least two electrical leads.

19. The heating apparatus of claim 17 wherein said at least one controller connector and said two bilaterally positioned connectors include at least three electrical leads.

20. The heating apparatus of claim 16 wherein said seat portion includes a thermostat.

21. The heating apparatus of claim 16 wherein controller connector and said two bilaterally positioned connectors are configured with complementary locking fittings.

22. The heating apparatus of claim 21 wherein the locking fittings are selected from the group consisting of screw caps and pressure fit fittings.

23. The heating apparatus of claim 16 wherein bilaterally positioned connectors are located along sides said vehicle seat cover near the intersection of said seat portion and said back portion.

24. The heating apparatus of claim 17 wherein one of said heating elements is located in said seat portion and one of said heating elements is located in said back portion.
